(19) United States
(12) Patent Application Publication
(10) Pub. No.: US 2014/0101595 A1
(43) Pub. Date: Apr. 10, 2014

(54) SYSTEM AND METHOD FOR UTILIZING A DYNAMIC VIRTUAL KEYBOARD

(71) Applicant: INFOSYS LIMITED, Bangalore (KA) (IN)

(72) Inventors: Praveena Deviprasad Kumara, Bangalore (IN); Raghavendra Bangalore Venkata Reddy, Bangalore (IN)

(73) Assignee: INFOSYS LIMITED, Bangalore (KA) (IN)

(21) Appl. No.: 13/984,598

(22) PCT Filed: Sep. 9, 2011
(86) PCT No.: PCT/IB11/02688

§ 371 Date: Dec. 17, 2013

(30) Foreign Application Priority Data
Mar. 31, 2011 (IN) 1072/CHE/2011

(51) Int. Cl. G06F 3/0488

(52) U.S. Cl. CPC G06F 3/04886
USPC 715/773

(57) ABSTRACT

A system and method of providing a dynamic virtual keyboard having a QWERTY or randomized layout that is displayed on a user interface to allow a user to input authentication information into a selected field. A first character key and a second character key are exchanged from their respective actual positions to modified positions. Mapped information associated with the exchanged original and modified positions of the first and second character keys is stored in a memory. Selection by the user of at least the displayed first character key in the modified position by the user is detected and the stored mapped information is retrieved from the memory of the first character key, wherein the first character key is translated to the second character key based on the retrieved mapped information. An authentication array including the second character key is sent to a server to authenticate the user.

This application claims the benefit of Indian Patent Application Filing No. 1072/CHE/2011, filed Mar. 31, 2011, which is hereby incorporated by reference in its entirety.

### FIELD

The present disclosure relates to a system and method for utilizing a dynamic virtual keyboard.

### BACKGROUND

Existing banking or other web sites utilize a virtual keyboard that is displayed on a web page where the user is asked to input his or her authentication information (e.g. login, password, social security number and the like). The displayed virtual keyboard contains character key letters that are positioned in compliance with the standard QWERTY keyboard layout or are randomly placed with respect to one another. It is also common that the user is required to use his or her mouse to select the character keys on the virtual keyboard (as opposed to using their physical keyboard) to enter their authentication information. This is purposely done for security reasons, and in particular, to protect the user from hackers intending to steal the user's login and/or password information by use of event tracking software which may monitor the user's keystrokes. Additionally, the randomly placed character keys on the virtual keyboard serve to prevent other individuals in proximity to the user who attempt to visually view or eavesdrop on the user's keystrokes when he or she entering his/her password. However, the virtual keyboard layout has limitations as the randomly placed character keys make it burdensome and time consuming to the user, because the user is not familiar with the randomly placed keys and must manually search for the keys that he or she needs to select to enter the authentication information.

What is needed is a system and method that provides a dynamic virtual keyboard which is simple to use and also maintains the highest levels of security against hackers as the user enters his or her authentication information.

### SUMMARY

In an aspect, a method of providing a dynamic virtual keyboard comprises displaying a virtual keyboard having a QWERTY or randomized layout on a user interface. The virtual keyboard is configured to allow a user to input information into a selected field on the user interface, wherein a first character key and a second character key are exchanged from their respective original positions to modified positions on the virtual keyboard. The method includes storing mapped information associated with the exchanged original and modified positions of the first and second character keys in a memory. The method includes detecting a selection by the user of at least the displayed first character key in the modified position. The method includes retrieving the stored mapped information from the memory of the first character key and translating the first character key to the second character key based on the retrieved mapped information. The method includes sending an authentication array including the second character key to a server, wherein the server uses the authentication array and the second character key to authenticate the user.

In an aspect, a non-transitory machine readable medium having stored thereon instructions for providing a dynamic virtual keyboard, comprising machine executable code which when executed by at least one machine, causes the machine to display a virtual keyboard having a QWERTY or randomized layout on a user interface in which the virtual keyboard is configured to allow a user to input information into a selected field on the user interface. A first character key and a second character key are exchanged from their respective original positions to modified positions on the virtual keyboard. The machine also stores mapped information associated with the exchanged original and modified positions of the first and second character keys in a memory and detects a selection by the user of at least the displayed first character key in the modified position. The machine also retrieves the stored mapped information from the memory of the first character key and translates the first character key to the second character key based on the retrieved mapped information. The machine also sends an authentication array including the second character key to a server, wherein the server uses the authentication array and the second character key to authenticate the user.

In an aspect, a computer system comprises a server interface that is configured to allow communications with a server. The computer system includes a memory and a processor coupled to the server interface and the memory. The processor is operative to display a virtual keyboard having a QWERTY or randomized layout on a user interface in which the virtual keyboard is configured to allow a user to input information into a selected field on the user interface. A first character key and a second character key are exchanged from their respective original positions to modified positions on the virtual keyboard. The processor is configured to store mapped information associated with the exchanged original and modified positions of the first and second character keys in the memory. The processor is configured to detect a selection by the user of at least the displayed first character key in the modified position and retrieve the stored mapped information from the memory of the first character key. The processor is configured to translate the first character key to the second character key based on the retrieved mapped information. The processor is configured to send an authentication array including the second character key to a server, wherein the server uses the authentication array and the second character key to authenticate the user.

In one or more of the above aspects, the system and method indicates to the user via the display that the first character key and the second character key are exchanged to their modified positions. This can be done where the first character key and the second character key are color coded to a same color to indicate their exchanged positions. This can additionally/alternatively be done wherein the selection of the first key is input by the user via a physical keyboard. In one or more aspects, the selection of the first key is input by the user via the virtual keyboard and/or a physical keyboard. In one or more aspect, the system and method detects a third character key being selected by the user; determines that the memory does not contain stored mapped information associated with the third character key; and stores the third character key in the authentication array without translating the third character key.

### BRIEF DESCRIPTION OF THE DRAWINGS

FIG. 1 is a diagram of an example system environment that implements and executes the novel system and method of the present disclosure;

FIG. 2A is a block diagram of a client device shown in FIG. 1;

FIG. 2B is a block diagram of a server device shown in FIG. 1;

FIG. 3A illustrates a keyboard with a QWERTY layout;

FIGS. 3B and 3C illustrates a user interface having the dynamic virtual keyboard in accordance with an aspect of the present disclosure;

FIG. 3D illustrates a keyboard with a randomized key layout; and

FIG. 4 is an example flow chart diagram depicting portions of processes between one or more client devices and one or more servers in accordance with the present disclosure.

### DETAILED DESCRIPTION

The present disclosure is directed to a system and method for providing dynamic virtual keyboard having a QWERTY or randomized layout which exchanges the positions of two or more character keys. As will be discussed in more detail below, the present system and method performs an algorithm which causes one or more pairs of character keys on the displayed virtual keyboard to be positionally swapped or exchanged with respect to their original positions within the keyboard layout. During the authorization process, the user is asked to input his/her secret authentication information, whereby the user will select one or more of the exchanged character keys if that character key is part of the user's login and/or password. The exchanging of character keys provides improved security to the user in light of hackers, event listeners or eavesdroppers who attempt to discern the user's authentication information (e.g. login and/or password) information by tracking the user's selection of character keys while the user inputs his/her login and/or password information. In particular, if a user selects a character key that has been positionally swapped, a hacker will be unable to determine the identity of actual key that the user intended to select since the hacker will not be able to view the other character key with which the selected key has been swapped. Additionally, the swapping of at least two character keys makes it easy for a user to use as the exchanged keys are preferably identified to the user, whereby the user need only select the “other key” which has been swapped with the key that the user needs to select in inputting his/her authentication information.

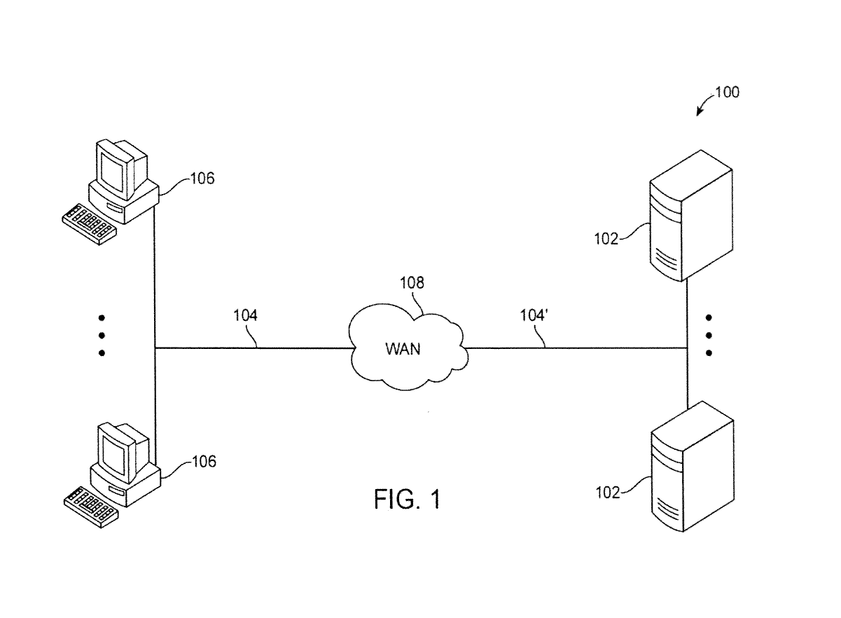

Referring now to FIG. 1, an example system environment 100 that includes one or more servers 102, such as a Web application server, and one or more client devices 106, although the environment 100 could include other numbers and types of devices in other arrangements. The web application servers 102 are connected to a local area network (LAN) 104 and the client devices 106 to a wide area network 108 in which the client devices 106 communicate with the Web application servers 102 via the wide area network 108 and one or more LANs 104. It should be noted that although more than one client device 106 and server 102 are shown in FIG. 1, any number of client devices 106, including only one, as well as any number of servers 102, including only one, are contemplated. It should also be noted that although client device and/or server may be referred to in the plural within the specification, it is contemplated that only one client device and/or one server may be considered without being limiting to the language used herein. It should be understood that the devices and the particular configuration shown in FIG. 1 are provided for exemplary purposes only and thus are not limiting.

Client devices 106 comprise computing devices capable of connecting to other computing devices, such as the Web application servers 102. Such connections are performed over wired and/or wireless networks, such as network 108, to send and receive data, such as for Web-based requests, receiving responses to requests and/or performing other tasks, in accordance with the novel processes described herein. Non-limiting and non-exhausting examples of such devices include personal computers (e.g., desktops, laptops), mobile and/or smart phones, kiosks, personal tablets, PDAs and the like. In an example, client devices 106 may be configured to run a Web browser that may provide an interface for operators, such as human users, to interact with for making requests for resources from one or more web server-based applications or Web pages via the network 108. It should be noted that it is contemplated that other server resources may be requested by the client devices 106. One or more Web-based applications may run on the web application server 102 that provide the requested data back to one or more exterior network devices, such as client devices 106.

Network 108 comprises a publicly accessible network, such as the Internet, which includes client devices 106. However, it is contemplated that the network 108 may comprise other types of private and public networks that include other devices. Communications, such as requests from clients 106 and responses from servers 102, take place over the network 108 according to standard network protocols, such as the HTTP and TCP/IP protocols in this example. However, the principles discussed herein are not limited to this example and can include other protocols.

Further, it should be appreciated that network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs and other networks to enable messages and other data to be sent from and to network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. In essence, the network 108 includes any communication method by which data may travel between client devices 106 and the Web application servers 102, and the like.

LAN 104 may comprise one or more private and public networks which provide secured access to the servers 102. Networks, including local area networks, besides being understood by those skilled in the relevant arts, have already been generally described above in connection with network 108 and thus will not be described further.

Web application server 102 comprises one or more server computing machines capable of operating one or more Web-based applications that may be accessed by network devices (e.g. client devices, other servers) in the network 108. Such network devices include client devices 106 which may provide other data representing requested resources, such as particular Web page(s), image(s) of physical objects, and any other objects, responsive to the requests. It should be noted that the server 102 may perform other tasks and provide other types of resources. It should be noted that one or more of the Web application servers 102 may be a cluster of servers managed by a network traffic management device, gateway device, router, hub and the like.

As per the TCP/IP protocols, requests from the requesting client devices 106 may be sent as one or more streams of data packets over network 108 to the Web application servers 102. Such protocols can establish connections, send and receive data for existing connections, and the like. It is to be understood that the one or more Web application servers 102 may be hardware and/or software, and/or may represent a system with multiple servers that may include internal or external networks. In this example, the Web application servers 102 may be any version of Microsoft® IIS servers, RADIUS servers and/or Apache® servers, although other types of servers may be used. Further, additional servers may be coupled to the network 108 and many different types of applications may be available on servers coupled to the network 108.

Each of the Web application servers 102 and client devices 106 may include one or more central processing units (CPUs), one or more computer readable media (i.e., memory), and interface systems that are coupled together by internal buses or other links as are generally known to those of ordinary skill in the art.

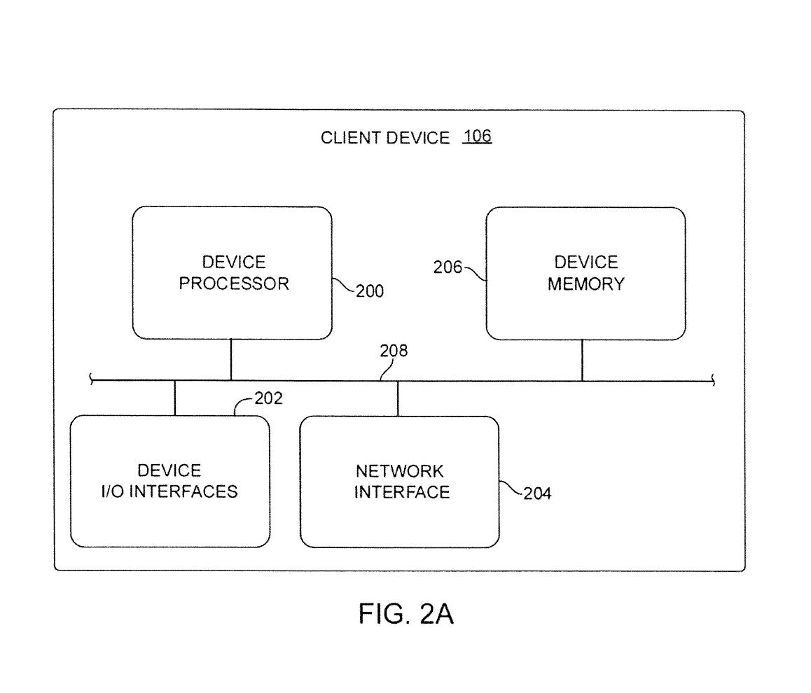

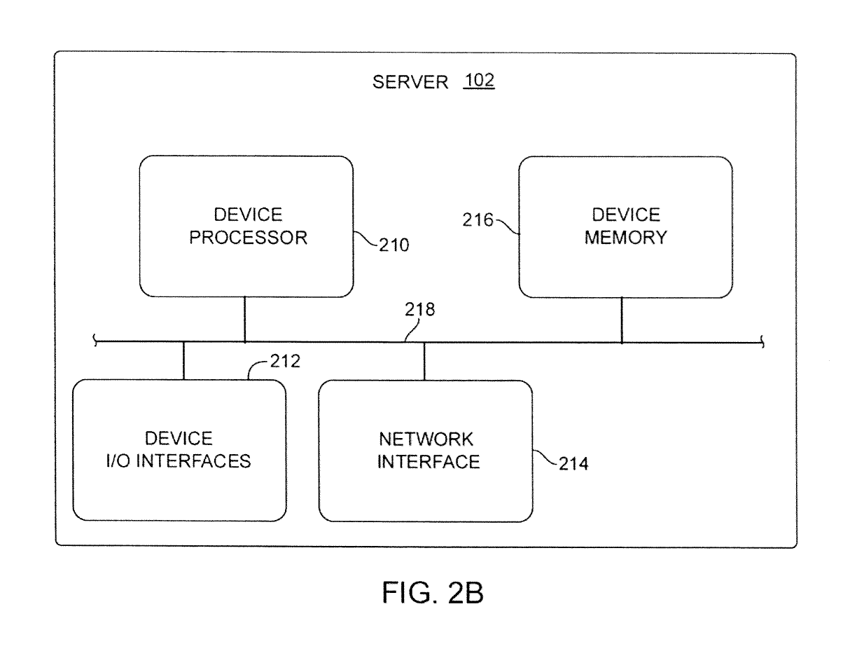

Referring now to FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components. Additionally, with regard to FIG. 2B, an example server 102 is shown which includes one or more device processors 210, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the device memory 206, 216. Such instructions are implemented by the client device 106 and/or server 102 to perform the functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein with respect to novel method described below.

Device I/O interfaces 202, 212 comprise one or more user input and output device interface mechanisms. The interface may include a computer keyboard, mouse, display device, and the corresponding physical ports and underlying supporting hardware and software to enable communication with other devices over the network 108. Such communications may include, but are not limited to, accepting user data input and providing output information to a user, programming and administering one or more functions to be executed by the corresponding device and the like.

Network interface 204, 214 comprises one or more mechanisms that enable the client device 106 and/or the server 102 to engage in TCP/IP communications over LAN 104 and network 108. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets to one or more networks, such as LAN 104 and network 108. In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214. Further, the network interface 204, 214 may include one or more physical ports, such as Ethernet ports, to couple its respective device with other network devices in the system 100. Moreover, the interface 204, 214 may include certain physical ports dedicated to receiving and/or transmitting certain types of network data, such as device management related data for configuring the respective device.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media contains computer readable/machine-executable instructions, data structures, program modules, or other data, which may be obtained and/or executed by one or more processors, such as device processor 200, 210. Such instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by a computing or specially programmed device 102, 106.

Although an example of the server 102 and the client device 106 is described and illustrated herein in connection with FIGS. 1 and 2A-2B, each of the computers of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s). Furthermore, each of the devices of the system 100 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like. The devices may be programmed according to the teachings as described and illustrated herein, as will be appreciated by those skilled in the computer, software, and networking arts.

In addition, two or more computing systems or devices may be substituted for any one of the devices in the system 100. Accordingly, principles and advantages of distributed processing, such as redundancy, replication, and the like, also can be implemented, as desired, to increase the robustness and performance of the devices and systems of the system 100. The system 100 may also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

The present disclosure is directed to a system and method for providing dynamic virtual keyboard having a QWERTY or randomized character key layout on a user interface. IN particular, the virtual keyboard is presented in a way that the positions of two or more character keys are positionally exchanged on the displayed keyboard. However, the exchanged keys are mapped with one another such that the selection by the user of one of the exchanged keys will result in the selection of the other exchanged key into the required input field. In particular, the present system and method performs an algorithm, preferably on a client device and/or server, which selects two or more character keys to be swapped or exchanged with respect to their positions on the virtual keyboard. Additionally, the system and method stores mapped positional data of the exchanged keys in a memory. Thus, if the user selects one of the exchanged keys, the client device or server will retrieve the stored mapped positional data and automatically swap the user selected key with the other key that it had originally been exchanged with. The swapped key is then placed in the proper position in a character array which is then sent to the proper server for authentication of the user's credentials.

The exchanging of character keys provides improved security to the user in light of hackers, event listeners or eavesdroppers who attempt to discern the user's authentication information (e.g. login and/or password) information by tracking the user's selection of character keys while the user inputs his/her login and/or password information. In particular, if a user selects a character key that has been positionally swapped, a hacker will be unable to determine the identity of actual key that the user intended to select since the hacker will not be able to view the other character key with which the selected key has been swapped. Additionally, the swapping of at least two character keys makes it easy for a user to use as the exchanged keys are preferably identified to the user, whereby the user need only select the “other key” which has been swapped with the key that the user needs to select in inputting his/her authentication information.

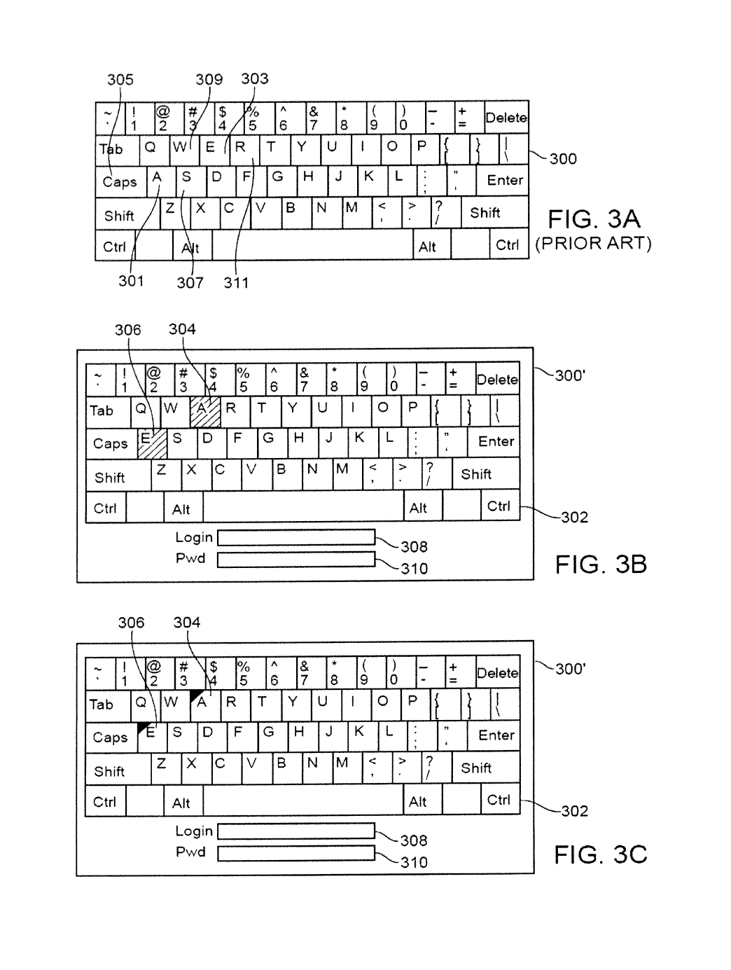

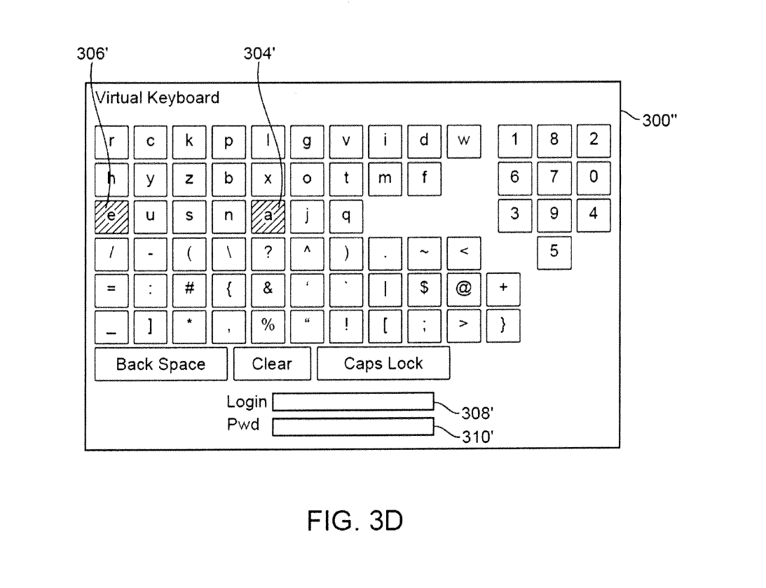

FIG. 3A illustrates a QWERTY keyboard layout in accordance with the prior art. As can be seen in FIG. 3A, for purposes the present disclosure, the QWERTY keyboard has a widely accepted character key layout which has been used for over a century. In particular to the ensuing description, the public is familiar to the QWERTY layout, whereby many who use a QWERTY based keyboard know the precise locations of all the character keys. For example, the character keys, “A” and “E” are shown in their actual positions on the QWERTY keyboard in FIG. 3A. In particular, the “A” character key 301 is shown between the “CAPS” lock key 305 and the “S” key 307 on the left side of the keyboard 300. Additionally, the “E” character key 303 is typically found between the “W” key 309 and the “R” key 311.

FIG. 3B illustrates a user interface, such as on a web page or other displayed user interface, whereby the user is requested to input his/her authentication information (e.g. login, password, etc.) into a desired input field. In an aspect, the user interface displays a virtual keyboard having character keys positions in compliance with the QWERTY layout. However, the virtual keyboard shown in FIG. 3B is modified such that at least one pair of character keys are exchanged with respect to their original positions in the traditional QWERTY keyboard layout. In particular to FIG. 3B, an algorithm is executed by a client device or server which causes the “A” and the “E” character keys to be swapped or exchanged such that the position of the “A” key is where the “E” key is typically placed and the “E” key is placed where the “A” key is typically placed on the traditional QWERTY keyboard. It should be noted that although only two character keys have been exchanged, any number of even or odd number of character keys may be positionally exchanged in accordance with the present disclosure. It should also be noted that although letters “A” and “E” are used in the example, any other character keys such as numbers, lower case letters, symbols, functional keys (e.g. F2, Shift, Caps) may be exchanged in accordance with the present disclosure.

As shown in FIG. 3B, the exchanged character keys are identified such that the user is able to easily identify which characters have been positionally swapped. In an aspect, this identification or designation is done by color coding only the exchanged keys while the other keys do not exhibit such a color coding, as shown in FIG. 3B. In an aspect, the exchanged character keys may be marked with a dog-ear (FIG. 3C), border, highlight or other manipulating feature such that the user is able to easily identify which characters have been exchanged. It is contemplated that the exchanged keys can be identified in other ways to notify the user of which keys have been swapped. Of course, in an aspect, it is contemplated that system may not manipulate or alter the swapped keys, thereby leaving all the keys looking the same.

It should be noted that although a QWERTY based layout is described above, it is contemplated that the present disclosure is applicable to a randomized virtual keyboard. In an aspect, the virtual keyboard may be displayed such that the character keys are randomly positioned with respect to one another on the user interface, as shown in FIG. 3D. In an aspect, the algorithm is configured such that, once executed by the processor on the client device and/or server, two or more character keys are positionally exchanged with respect to one another. In an aspect, the exchanged or swapped character keys are identified to the user in a way that the user is able to discern that the selection of one of the identified exchanged keys will result in the actual selection of the other identified key.

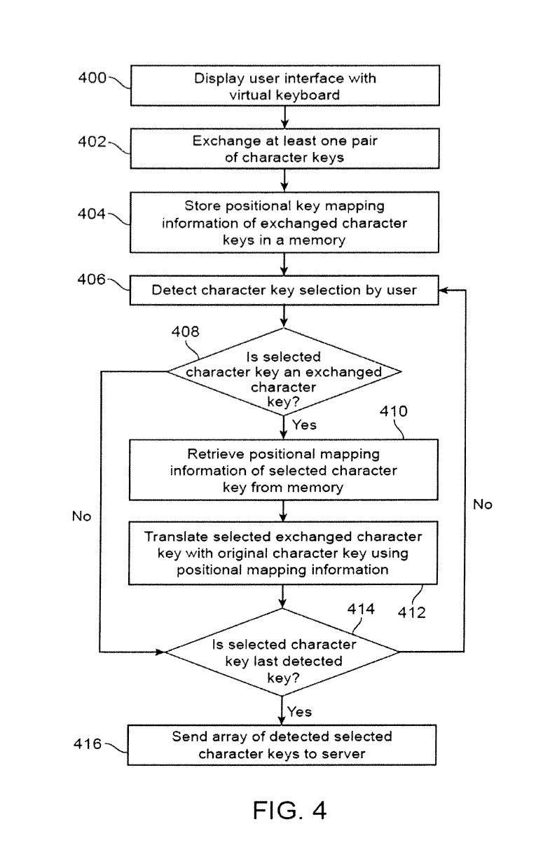

FIG. 4 illustrates a process flowchart describing the method of the present disclosure in relation to the user interface 300′ shown in FIGS. 3B and 3C. As shown in FIG. 4, the process begins when a user visits a displayed user interface 300′ (e.g. on a web page, kiosk screen, mobile device or the like). As shown in FIGS. 3B and 3C, the user interface 300′ requests the user to input his/her user credential information or other authentication information into one or more displayed designated input fields, such as the login field 308, password field 310, and the like (FIGS. 3B and 3C). In addition, the user interface 300′ displays a virtual keyboard having a QWERTY or randomized key layout 302 (FIGS. 3B-3D) (block 400). As further described below, the user is able to use the virtual keyboard 302, a physical keyboard (not shown), or a combination of the two, to input his/her authentication information into the one or more designated input fields 308, 310.

As shown in FIG. 4, the processor on the client device 106 executes an algorithm, preferably stored in the memory 206, which causes at least two character keys to be exchanged with regard to their actual positions on the virtual keyboard (block 402). In an example, the “A” character key 304 is automatically exchanged with the “E” character key 306 with respect to their actual positions on a QWERTY keyboard (FIGS. 3B-3C) or randomized keyboard (FIG. 3D). Therefore, the algorithm causes the “A” character key 304 to be effectively moved to a modified position where the “E” character key is actually positioned. Likewise, the algorithm causes the “E” character key to be effectively moved to a modified position where the “A” character key is actually positioned. It should be noted that it is contemplated that other character keys can be exchanged and thus is not limited to the “A” and “E” character keys in the example. It should also be noted that more than two character keys may be exchanged and displayed on the virtual keyboard. In an aspect, three or more character keys may be exchanged on the displayed virtual keyboard in which each of the exchanged keys are in their modified positions.

In aspect, the exchanged character keys are specifically identified to the user so that the user is notified which character keys have been swapped, although this is not required. This may be done by the applying a same color, border, highlight or other feature to only the exchanged character keys so that the user is able to immediately identify which character keys have been swapped with respect to their actual positions. In an example, the “A” and “E” keys may be modified to have the same color whereas the other character keys do not have that color. In another example, the processor manipulates the “A” and “E” character keys (e.g. capitalized, character buttons are larger, etc.) to specifically identify them as being exchanged whereas the non-exchanged character keys are not manipulated in that manner.

Regarding the algorithm run by the processor in the client device, the algorithm may be configured to randomly choose which and how many character keys to positionally exchange. Additionally or alternatively, the algorithm may be configured to specifically choose which character keys to exchange based on the user's authentication information. In this aspect, the processor 200 is provided with enough information of the user's authentication information to be able to selectively choose which character keys to exchange. In an aspect, at least a portion of the algorithm is implemented using a script language (e.g. Javascript) which causes the automatic exchange of character keys that are displayed on the virtual keyboard. In another aspect, the automatic exchange of character keys can be preselected and programmed by an administrator into the script language or other code that is eventually run by the client device 106 to display the exchanged character keys.

Referring back to FIG. 4, the processor monitors and stores positional mapping information of the exchanged character keys with regard to the actual and modified positions in a memory 206 (block 404). In the present example, the positional mapping information will indicate that the “A” key and “E” key have been exchanged with respect to their actual positions on the virtual keyboard. The stored key mapping information may be in the form of a look up table or other format in the memory to facilitate easy retrieval of the positional mapping information by the processor 200.

As shown in FIG. 4, the process continues in which the processor 200 detects the user's input of one or more character keys on the displayed virtual keyboard and/or physical keyboard to enter his or her authentication information (block 406). As noted above, the character keys which had been exchanged on the displayed virtual keyboard may or may not be part of the user's authentication information. In the above first example, the user's password may be “EURO” and the exchanged character keys are the “A” and “E” keys shown in FIGS. 3B-3D. However, in a second example, the user's password may be “PONY” even though the exchanged character keys are the “A” and “E” keys shown in FIGS. 3B-3D.

Thus, in block 408, the processor determines whether the detected key that the user selected is one of the character keys that had been exchanged on the displayed virtual keyboard. In aspect, this is performed by the processor 200 comparing the selected character key with the stored mapping information to determine if the selected key is one of the exchanged keys. However, it is contemplated that alternative methods may be implemented to determine if the key that the user selects is one of the exchanged character keys.

If it is determined that the user's key selection is not one of the exchanged character keys, the process continues to block 414, which is described below. For instance, with respect to the second example described above, if the processor 200 detects that the user has selected the “P” character key, the processor will conclude that the selected character key is not one of the exchanged “A” or “E” keys after checking the stored mapping information. In this instance, the processor places the “P” character in the array of characters which are to be eventually transmitted to a server to authenticate the user's credentials. It should be noted that the key selected by the user may be displayed in the input field on the user interface as the actual key, the modified key selected by the user, an asterisk which does not display any character and the like.

In contrast, if the processor 200 concludes that the selected key is one of the exchanged character keys, the processor 200 retrieves the positional mapping information of that selected key previously stored in the memory (block 410). For instance, with respect to the first example described above, if the processor 200 detects that the user has selected the “A” character key (in typing the first letter of the password “EURO”), the processor will conclude that the selected character key is one of the exchanged “A” or “E” keys after checking the stored mapping information. In particular, the processor will process the stored mapping information and determine that the “A” character in modified position in the virtual keyboard is actually the “E” character in its actual position on the virtual keyboard.

Thereafter, the processor will translate or re-exchange the user-selected character key with the actual character key from the retrieved positional mapping information (block 412). Referring back to the first example, the processor will translate the “A” key, which was entered by the user, to an “E” to be placed in its appropriate order in an array to be eventually sent to an authenticating server.

In an aspect, the processor 200 can determine whether the user has completed entering additional characters in inputting his/her authentication information (block 414). If the processor determines that another key is selected by the user, the process repeats back to block 406. In contrast, if the processor 200 determines that the user has selected his/her last character key, the client device 106 sends the entered characters, along with the translated character keys, as an array to a designated server to authenticate the user's credentials (block 416).

It should be noted that although the above process has been described has been performed by a client device 106, it is contemplated that the process can also be implemented and executed on the server side 102 (FIG. 2B), whereby the processor 210 within the server 102 executes one or more of the steps shown in FIG. 4 and the memory 216 stores the information as described in FIG. 4.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of providing a dynamic virtual keyboard comprising:
displaying a virtual keyboard on a user interface in which the virtual keyboard is configured to allow a user to input information into a selected input field on the user interface, wherein a first character key and a second character key are exchanged from their respective actual positions to modified positions on the virtual keyboard via one or more processors;
storing mapped information associated with the exchanged actual and modified positions of the first and second character keys in a memory;
detecting a selection by the user of at least the displayed first character key in the modified position;
retrieving the stored mapped information from the memory of the first character key, wherein the stored mapped information identifies the first character key as being swapped with the second character key;
translating the first character key to the second character key based on the retrieved mapped information; and
sending an authentication array including the second character key to a server, wherein the server uses at least the second character key to authenticate the user.

2. The method of claim 1, further comprising indicating to the user via the display that the first character key and the second character key are exchanged to their modified positions.

3. The method of claim 2, wherein the first character key and the second character key are color coded to a same color to indicate their exchanged positions.

4. The method of claim 1, wherein the selection of the first key is input by the user via a physical keyboard.

5. The method of claim 1, wherein the selection of the first key is input by the user via the virtual keyboard.

6. The method of claim 1, wherein at least a portion the displayed virtual keyboard has a QWERTY layout.

7. The method of claim 1, wherein the character keys are randomly positioned on the displayed virtual keyboard.

8. The method of claim 1, further comprising:
detecting a third character key being selected by the user;
determining that the memory does not contain stored mapped information associated with the third character key; and
storing the third character key in the authentication array without translating the third character key.

9. The method of claim 1, wherein the one or more processors execute an algorithm configured to positionally exchange the first and the second character keys.

10. A non-transitory machine readable medium having stored thereon instructions for providing a dynamic virtual keyboard, comprising machine executable code which when executed by at least one machine, causes the machine to:
display a virtual keyboard on a user interface in which the virtual keyboard is configured to allow a user to input information into a selected field on the user interface, wherein a first character key and a second character key are exchanged from their respective actual positions to modified positions on the virtual keyboard;
store mapped information associated with the exchanged actual and modified positions of the first and second character keys in a memory;
detect a selection by the user of at least the displayed first character key in the modified position;
retrieve the stored mapped information from the memory of the first character key, wherein the stored mapped information identifies the first character key as being swapped with the second character key;
translate the first character key to the second character key based on the retrieved mapped information; and
send an authentication array including the second character key to a server, wherein the server uses at least the second character key to authenticate the user.

11. The machine readable medium of claim 10, further comprising causing the machine to indicate to the user via the display that the first character key and the second character key are exchanged to their modified positions.

12. The machine readable medium of claim 11, wherein the first character key and the second character key are color coded to a same color to indicate their exchanged positions.

13. The machine readable medium of claim 10, wherein the selection of the first key is input by the user via a physical keyboard.

14. The machine readable medium of claim 10, wherein the selection of the first key is input by the user via the virtual keyboard.

15. The machine readable medium of claim 10, wherein at least a portion the displayed virtual keyboard has a QWERTY layout.

16. The machine readable medium of claim 10, wherein the character keys are randomly positioned on the displayed virtual keyboard.

17. The machine readable medium of claim 10, further comprising causing the machine to:
detect a third character key being selected by the user;
determine that the memory does not contain stored mapped information associated with the third character key; and
store the third character key in the authentication array without translating the third character key.

18. The machine readable medium of claim 10, further comprising causing the machine to execute an algorithm configured to positionally exchange the first and the second character keys.

19. A computer system comprising:
a server interface configured to allow communications with a server;
a memory;
a processor coupled to the server interface and the memory, the processor operative to:
display a virtual keyboard on a user interface in which the virtual keyboard is configured to allow a user to input information into a selected field on the user interface, wherein a first character key and a second character key are exchanged from their respective actual positions to modified positions on the virtual keyboard;
store mapped information associated with the exchanged original and modified positions of the first and second character keys in a memory;
detect a selection by the user of at least the displayed first character key in the modified position by the user;
retrieve the stored mapped information from the memory of the first character key, wherein the stored mapped information identifies the first character key as being swapped with the second character key;
translate the first character key to the second character key based on the retrieved mapped information; and
send an authentication array including the second character key to a server, wherein the server uses at least the second character key to authenticate the user.

20. The computer system of claim 19, wherein the processor is configured to indicate to the user via the display that the first character key and the second character key are exchanged to their modified positions.

21. The computer system of claim 20, wherein the first character key and the second character key are color coded to a same color to indicate their exchanged positions.

22. The computer system of claim 19, wherein the selection of the first key is input by the user via a physical keyboard.

23. The computer system of claim 19, wherein the selection of the first key is input by the user via the virtual keyboard.

24. The computer system of claim 19, wherein the processor is configured to:
detect a third character key being selected by the user;
determine that the memory does not contain stored mapped information associated with the third character key; and
store the third character key in the authentication array without translating the third character key.

25. The computer system of claim 19, wherein at least a portion the displayed virtual keyboard has a QWERTY layout.

26. The computer system of claim 19, wherein the character keys are randomly positioned on the displayed virtual keyboard.
